(19) United States
(12) Patent Application Publication
(10) Pub. No.: US 2010/0118662 A1
(43) Pub. Date: May 13, 2010

(54) CLOCK KIT WITH INDEPENDENTLY MOUNTABLE DIAL

(75) Inventor: Christina Smith, Orem, UT (US)

Correspondence Address: Workman Nydegger;1000 Eagle Gate Tower, 60 East South Temple, Salt Lake City, UT, 84111, US

(73) Assignee: DCWV ACQUISITION CORPORATION, Provo, UT (US)

(21) Appl. No.: 12/609,569

(22) Filed: Oct. 30, 2009

Related U.S. Application Data
(60) Provisional application No. 61/112,544, filed on Nov. 7, 2008.

(51) Int. Cl. G04B 19/06; G04D 3/00

(52) U.S. Cl. 368/228; 29/896.3

(57) ABSTRACT

A clock kit includes a clock mechanism having a plurality of clock hands and a sticker assembly having a plurality of stickers providing indicia corresponding to a plurality of positions for the plurality of clock hands and positioned between at least one liner sheet and at least one liner sheet. A first adhesive force between a first side of the stickers and the liner sheet is less than a second adhesive force between a second side opposing side of the stickers and the transfer sheet. A third adhesive force between the first side of the stickers and a surface on which the clock kit is to be mounted is greater than the second adhesive force.

### RELATED APPLICATIONS

This application claims the benefit of U.S. Provisional Patent Application Ser. No. 61/112,544 filed Nov. 7, 2008 and entitled “Clock Kit with Independently Mountable Dial,” the disclosure of which is hereby incorporated by reference in its entirety.

### BACKGROUND OF THE INVENTION

1. The Field of the Invention

This invention is in the field of clocks, such as wall clocks, and other clocks having clock faces that employ numbers or other indicia to correspond to and identify the position of the clock hands.

2. The Relevant Technology

A wide variety of clocks have clock faces having dials that employ numbers or other indicia to identify the position of the clock hands as the clock hands turn about the dial. Typically, clock faces are comprised of (i) a plurality of clock hands (e.g., hour, minute, and second hands) and a dial (e.g., a circular shaped dial) having numbers and/or other graduations or markings, all of which are examples of “indicia,” that correspond to and identify the position of the clock hands.

For example, in a typical clock that employs a plurality of clock hands to indicate the time of day, e.g., in an analog clock, when the hour hand is located at the numeral six on a clock dial and the minute hand is located at the numeral twelve on the clock dial, the time is commonly known to be six o'clock. The dial corresponds to the position of the clock hands and serves both to provide an accurate indication of the time of day, e.g., twelve noon, one thirty, etc., and also serves a decorative function by providing a stylistic appearance.

### SUMMARY OF THE INVENTION

The present invention relates to a clock kit with a dial that is mountable independently from the clock mechanism. The clock kit includes a clock mechanism having a clock motor assembly and a plurality of clock hands. The hands are connected to and operated, i.e., turned, by the clock motor assembly.

A clock dial that is independent from the clock mechanism is provided. The clock dial can be mounted on a wall surface or other surface. The clock mechanism is then conveniently mounted on the surface and is oriented in such a manner that the pivot points of the clock hands are located in the center of the clock dial. In one embodiment, the clock dial is at least one sticker that is adhered to a wall surface, after which a clock mechanism is mounted to the wall surface with the pivot points of the clock hands being located at the center of the clock dial formed by the at least one sticker.

The dial comprises a plurality of indicia that are independent from the clock mechanism and are mountable separately therefrom. The indicia are configured to be mounted on a wall surface. The indicia are selectively orientable at different locations on a particular surface as desired for decoration and use of the clock.

In one embodiment, the indicia, e.g., numbers 1-12, or other markings, graduations, and/or gradients, are provided in a circular array. However, a circular array is not required and more or less than 12 numbers or other indicia may also be provided. In another embodiment, a template can be provided separately from the stickers, which can be provided in a non-circular array. In such an example, the stickers can be separately placed using the template. In one embodiment, the circular array that forms the dial comprises one or more stickers that are selectively mounted on a surface, after which the clock mechanism is mounted on the surface. The one or more stickers can be a single contiguous sticker or a series of separate stickers arranged in a desired pattern so as to be positioned about the periphery of the clock mechanism. Thus, one or more stickers, i.e., at least one sticker, can be employed to form a desired clock dial. The one or more stickers serve as the indicia, e.g., numbers that correspond to the movement of the hands of the clock, thereby indicating the time of day. In another embodiment, a template can be provided separately from the stickers, which can be provided in a non-circular array. In such an example, the stickers can be separately placed using the template.

The one or more stickers provide a convenient decoration such that the stickers can be placed directly on a wall surface, after which the clock mechanism is placed thereon in the center of the stickers such that the hands of the clock move about the stickers.

The decoration that is provided by the stickers can have the pleasant appearance of numbers painted onto a wall surface, for example. By providing the clock numbers as one or more stickers, as opposed to hand painting the numbers on the wall, there is less likelihood that the clock numbers will be out of place or that that the resulting dial will not be an accurate circle or other desired shape. Stickers may also be provided to allow additional customizing of the clock dial and/or clock mechanism, e.g., stickers enabling the last name of the user and/or a particular date to be placed on a wall surface or on the clock mechanism.

The stickers may be mounted onto a wall surface or other surface in a similar manner to mounting a decal on a surface. In one embodiment, a sticker assembly of the present invention comprises a first flexible sheet of material, a second flexible sheet of material, and one or more stickers sandwiched therebetween. The first sheet of material serves as a transfer sheet on which the stickers rest in an aligned manner while they are being transferred as an organized group against a surface. The second sheet of material serves as a liner sheet to protect the adhesive side of the stickers until the stickers are transferred onto the surface.

Once the liner sheet is removed from the adhesive side of the stickers, the transfer sheet with the stickers is placed in a desired location on the wall surface or other surface. The adhesive side of the stickers is thereby placed against the surface. The user then rubs against the transfer sheet to firmly rub the stickers in place and remove any wrinkles. The transfer sheet is then removed, leaving the stickers in a desired orientation on the surface. The clock mechanism is then conveniently placed in the center of the array of stickers, forming a clock having a decorative dial that has the appearance of being elegantly painted on the surface.

The at least one sticker that forms the dial can be a single continuous sticker that includes all of the necessary indicia, e.g., numerals 1-12, or can be multiple stickers that include numerals 1-12, for example, and are positioned in a desired array such that the stickers can be placed on a surface in the formation of a clock dial.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A is a perspective view of a clock kit of the present invention, including the clock mechanism and a sticker assembly, which comprises: (i) a first flexible sheet (known as the transfer sheet); (ii) a second flexible sheet (known as the liner sheet); and (iii) a plurality of stickers positioned there-between which can be positioned on a wall surface or other surface to form the dial of a clock.

FIG. 1B shows a representation of the clock kit of the present invention including a container, such as a plastic container (e.g., a blister pack) for containing and shipping the components of the kit. An instructions sheet providing instructions for applying the stickers to a wall surface and mounting the clock mechanism thereon is also provided. In one embodiment, sticker assembly 20 is provided in the blister pack as a rolled up sheet.

FIG. 1C is a partial cross-sectional view of the transfer sheet, the liner sheet, and a portion of one of the plurality of stickers shown in FIG. 1A

FIG. 2 is a rear view of the clock mechanism of FIG. 1A.

FIG. 3 is a view of the sticker assembly of FIG. 1A wherein the liner sheet is being peeled away from the transfer sheet and away from an adhesive side of the plurality of stickers.

FIG. 4 is a view of the sticker assembly of FIG. 1A wherein the liner sheet 26 has been peeled away from the transfer sheet 22 and from the adhesive side of the plurality of stickers 24, which remain mounted on the transfer sheet 22.

FIG. 5 is a view demonstrating the placement of the transfer sheet of the sticker assembly of FIG. 1A, having the plurality of stickers mounted thereon, on a surface, such as a wall surface 36. FIG. 5 also shows the transfer sheet and the plurality of stickers being smoothed so as to be contiguous with the wall surface.

FIG. 6 is a view of the smoothed transfer sheet against the wall surface.

FIG. 7 is a view of the transfer sheet of the sticker assembly of FIG. 1 being peeled away from the wall surface and from the plurality of stickers such that the adhesive side of the plurality of stickers remains against the wall surface.

FIG. 8 is a view of the plurality of stickers of FIG. 1A (with the transfer and liner sheets removed there from) having been mounted on a surface to form a convenient, decorative clock dial that has the elegant appearance of being hand painted on a surface.

FIG. 9 is a view of the clock mechanism of FIG. 1A mounted on the surface adjacent the plurality of stickers shown in FIG. 8 in order to form a clock in which the numerical indicia that indicate the time of day are mounted directly on the surface such that the clock hands extend about the periphery of the dial defined by the plurality of stickers.

FIG. 10 is an example of an instruction sheet for use in conjunction with one embodiment of the present invention, the text and disclosure of which is incorporated into this specification by reference.

FIG. 11 is yet another embodiment of a sticker assembly 20a of the present invention having a transfer sheet 22a and a liner sheet 26a and the same stickers as the sticker assembly of FIG. 1A, but further having additional stickers 48 for decorating the surrounding surfaces and/or clock mechanism.

### DETAILED DESCRIPTION OF THE PREFERRED EMBODIMENTS

A clock kit is provided herein that includes a plurality of indicia and a clock mechanism. The indicia can include stickers, films, or other media configured to be adhered to a surface, such as a wall or other surface. In at least one example, one or more indicia are placed between a transfer sheet and a liner sheet in a configuration that allows the liner sheet to be removed while maintaining the indicia on one or more transfer sheet. The indicia on the transfer sheet(s) can be provided and grouped together so as to be placed together on a mounting surface together as a complete pattern or can be placed on the transfer sheet(s) so as to be placed individually to thereby allow a user to form a pattern using individual indicia as desired. Regardless of the configuration, providing the indicia as part of a clock kit can allow the indicia to be readily applied to the mounting surface. Further, the use of the transfer sheet can allow the indicia to be formed into intricate patterns as the likelihood of distortion during application is reduced as the transfer sheet supports the indicia and helps reduce unintended distortion or displacement of various portions of the indicia. Accordingly, the support provided by the transfer sheet can allow the indicia to be accurately applied to the mounting surface while retaining the actual mounted shape of the indicia as closely as possible to the intended shape. In addition, the support provided by the transfer sheet can allow for the use of thin layers of material or even films of materials, which can result in an appearance resembling a painted pattern. For example, layers as thin as 0.15 mm to about 0.02 mm or less can be applied as the indicia portion of the clock kit.

Various configurations are described below. While some exemplary embodiments and terminology are used, it will be appreciated that other configurations are possible. For example, for ease of reference the term “sticker” and “sticker assembly” will be used to described the indicia. It will be appreciated that the term sticker shall be broadly understood to mean any material, layer, or combinations of various layers and materials that form indicia configured to be applied to a mounting surface with the use of a transfer sheet. The term indicia shall be broadly understood to mean any visual cues that can be placed at angular intervals to represent any number of positions on a clock and in any arrangement. Further, though described as a single transfer sheet, it will be appreciate that the indicia can be separated into any number of individual elements, grouped as desired in patterns and/or arrangements, and/or be provided on perforated or otherwise separable larger sheets.

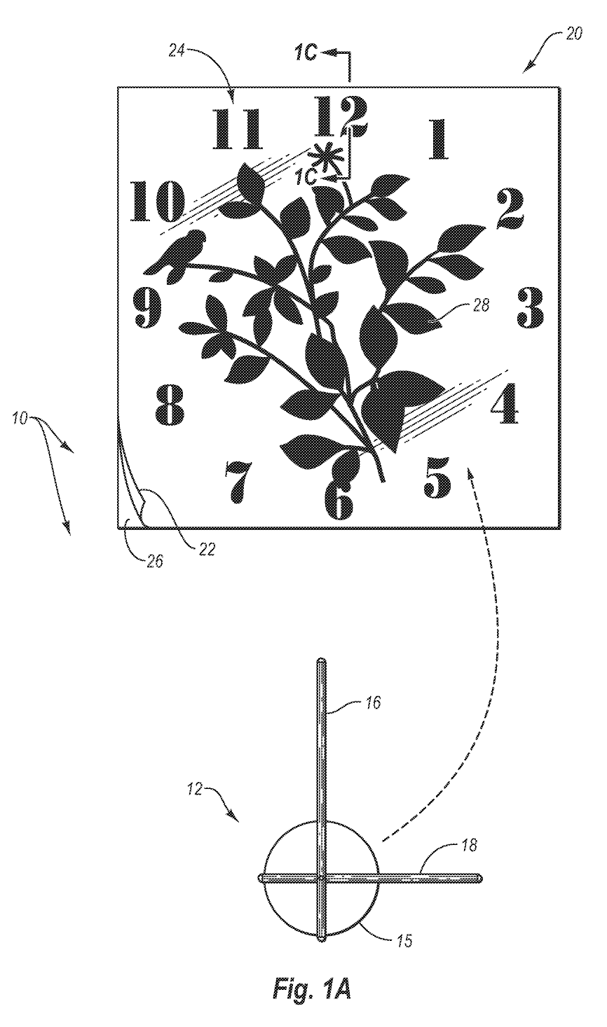

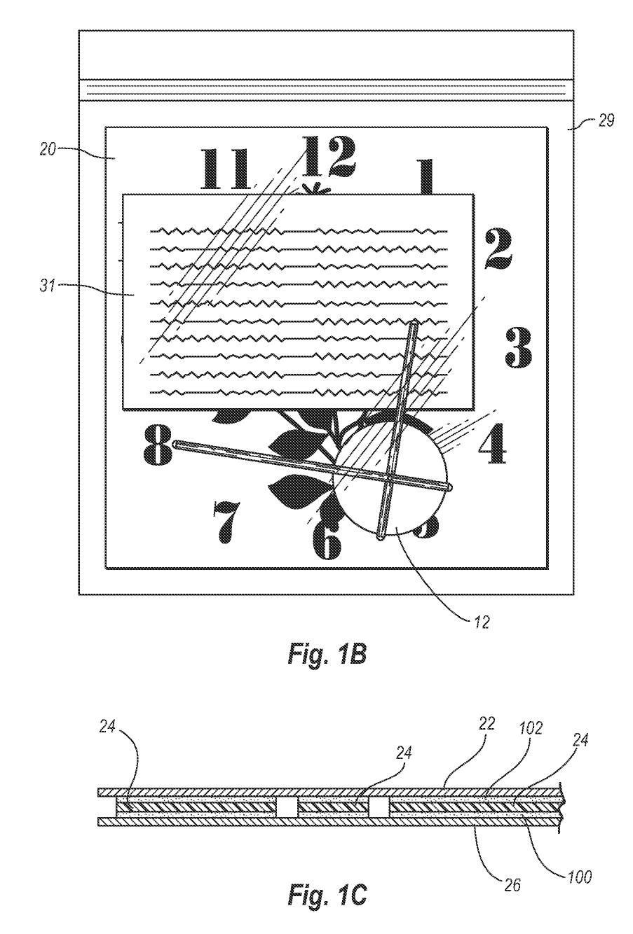

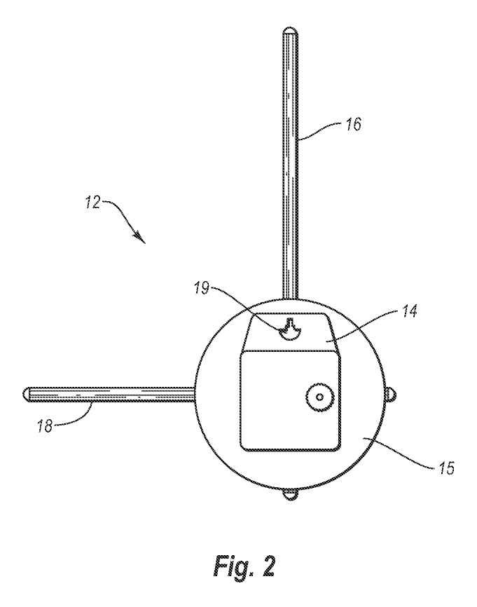

FIGS. 1A, 1B, 1C and 2 show a clock kit 10 of the present invention for mounting on a surface such as a wall surface. Clock kit 10 comprises: (i) a clock mechanism 12, having a motor assembly 14 and a plurality of hands 16, 18; and (ii) a sticker assembly 20 comprising a first flexible sheet 22, a plurality of stickers 24, and a second flexible sheet 26. The plurality of stickers 24 are sandwiched between the first flexible sheet 22, which is a translucent or transparent sheet, and the second flexible sheet 26.

The plurality of stickers 24 comprise a plurality of indicia, e.g., numbers one through twelve, and/or certain decorative pieces 28. First flexible sheet 22 is known as a transfer sheet because it is employed to transfer stickers 24 to a surface. Second flexible sheet 26 is known as a liner sheet because it provides a liner for the adhesive side of the stickers 24 prior to placing the stickers 24 on the surface.

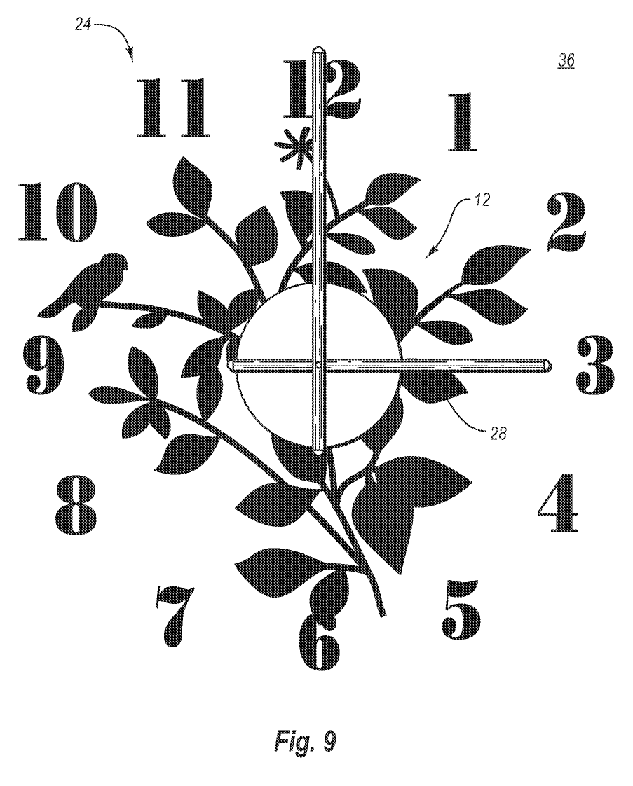

The stickers numbered 1-12 of FIGS. 1A-1B are arranged between flexible sheets 22, 26 in a circular array so as to collectively form a clock dial that corresponds to the position of hands 16, 18 as hands 16, 18 move in a circular motion once clock mechanism 12 has been placed in the center of sticker assembly 20, as illustrated in FIG. 9, which will be discussed in further detail below. Transfer sheet 22 maintains the stickers 24 in an organized fashion until they are transferred to the surface.

Sticker assembly 20 is configured to be mounted on a surface such as a wall surface in order to form a clock dial such that the wall or the surface upon which the plurality stickers 24 are mounted is effectively a clock dial upon which clock mechanism 12 can be mounted. Thus, sticker assembly 20 provides a decorative clock dial upon which clock mechanism 12 can be mounted to form a clock with an elegant appearance.

In one example, the entire sticker assembly 20 can be placed on the mounting surface as a single, complete pattern. In other examples, each of the stickers 24 can be placed using a corresponding portion of transfer sheet 22 individually on the mounting surface to form the desired pattern.

As shown in FIGS. 1A-2, clock mechanism 12 can comprise a face plate 15 for decoratively covering clock motor assembly 14. FIG. 2 is a depiction of a clock mechanism 12 having a motor assembly 14, hands 16, 18 turned by motor assembly 14, and a mounting bracket 19 connected to motor assembly 14 for convenient mounting of clock mechanism 12 on a wall surface or other surface.

Clock mechanism 12 may be mounted to a surface using a variety of different mechanisms such as a nail, screw, hanger or other coupler coupled to the surface upon which bracket 19 of clock mechanism 12 is mounted. In one embodiment, the coupler upon which bracket 19 is mounted is positioned such that the pivot point of hands 16, 18 is located in the center of the circular array of stickers 24. Clock mechanism 12 can also be mounted through the use of an adhesive or other couplers. In one embodiment, the sticker assembly includes a marking, such as an “x” to indicate where the coupler can be placed to enable alignment of the clock hands with the indicia.

Clock mechanism 12 is an example of an analog clock having an hour hand 18 and a minute hand 16. The clock mechanism can also have a second hand or a variety of other hands or components that are common to operable clocks. Motor assembly 14 is comprised of all of the necessary components to turn hands 16, 18 in a clock-like fashion so as to indicate the time of day. Motor assembly 14 may comprise, for example, a motor, gears train, housing, circuit board, power source, e.g. battery or electrical cord, movement, setting wheel and its pinion, cylinder, quartz crystal, wire coil, cylindrical magnet, and any other components employed to turn clock hands 16, 18 in a manner commonly known for indicating the accurate time of day. However, any clock that can be used in conjunction with a clock dial having numbers, markings, or other such indicia thereon, such as an analog clock, may be employed as a clock mechanism in the present invention.

The clock mechanism 12 can be obtained in a variety of different manners such as by purchasing or otherwise producing a clock mechanism 12 comprising a clock motor assembly 14 and a plurality of hands 16, 18.

FIG. 1a shows the clock kit 10 of the present invention including a container 29, such as a bag for carrying the components of the kit, and an instructions manual 31 providing instructions for applying the stickers to a wall surface and mounting the clock mechanism thereon.

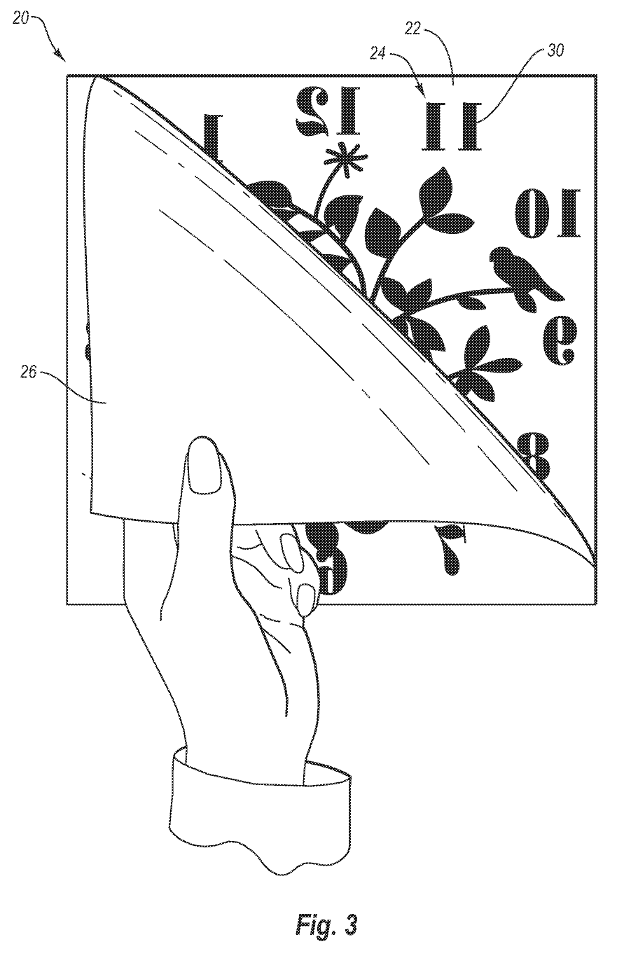

With reference now to FIGS. 3-9, a method will now be described for mounting wall clock kit 10 onto a wall surface 36. As shown in FIG. 3, sticker assembly 20 is employed to place plurality of stickers 24 onto a wall or other surface by first peeling away liner sheet 26 from stickers 24 and from first flexible sheet 22 thereby exposing an adhesive surface 30 of stickers 24 to the environment once sheet 26 is peeled away.

In one embodiment, sticker assembly 20 is provided as a rolled up sheet. Once sticker assembly 20 is unrolled and laid on a flat surface with the liner sheet 26 facing up, sticker assembly 20 can be smoothed and rubbed using applicator 37, such that liner 26 can be peeled away from stickers 24 and transfer sheet 22.

As shown in FIG. 1C illustrates the layers forming a portion of the sticker assembly 20 that include a sticker 24 between the transfer sheet 22 and the liner sheet 26. In such an example, a first adhesive layer 100 is applied to the rear side of the sticker 24. Such a configuration places the first adhesive layer 100 between the liner sheet 26 and the sticker 24 when the sticker assembly 20 for packing storage or transit, etc. A second adhesive layer 102 can optionally be applied to the front side of the sticker 24. Such a configuration can optionally place the second adhesive layer 102 between the transfer sheet 22 and the sticker 24. In other examples, adhesion between the sticker 24 and the transfer sheet 22 can provide the functionality described with reference to the second adhesive layer 102 discussed below.

In some examples, additional layers, such as coloring layers (not shown), including printed layers can be applied to the front portion of the sticker 24 before the second adhesive layer 102 is applied to color the front portion of the sticker 24 or apply a desired visual effect to the front portion of the sticker 24.

In at least one example, the interaction between the first adhesive layer 100 and the liner sheet 26 can result in a smaller adhesive force than that due to the interaction between the second adhesive layer 102 (and/or the front side of the sticker 24) and the transfer sheet 22. Such a configuration can allow the liner sheet 26 to be removed while maintaining the sticker 24 in contact with the transfer sheet 22. Thereafter, interaction between the first adhesive layer 100 and the surface on which it is mounted can result a larger adhesive force than that between the second adhesive layer 102 (and/or the front side of the sticker 24) and the transfer sheet 22. Such a configuration can allow the sticker 24 to adhere to the mounting surface as the transfer sheet 22 is removed. One exemplary method of mounting a sticker assembly 20 as part of a clock kit will now be discussed in more detail.

In at least one example, the first adhesive layer 100 can include, but is not limited to a polypropylene-based adhesive, the second adhesive layer 102 can include, but is not limited to latex-type adhesive. Colorant layers can include, but are not limited to silk screened or 4 Color Process inks. Transfer sheet materials can include, but are not limited to wet strength, wood-free base paper coated with a latex-type adhesive, liner sheet can include but is not limited to wood free paper coated with polyethylene and silicon. The stickers shown in FIG. 1C and discussed herein can have a thickness of between about 0.02 mm and about 0.15 mm or more.

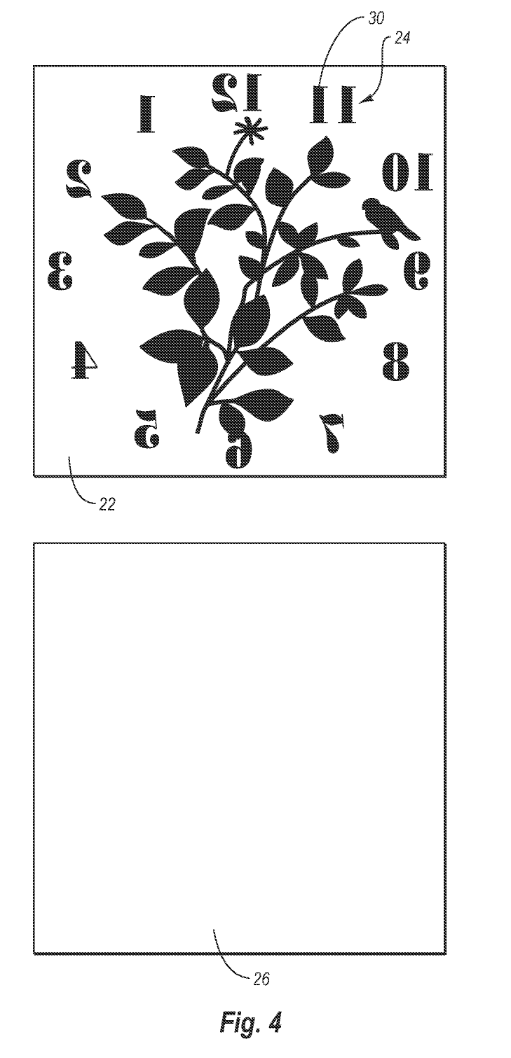

As shown in FIGS. 3 and 4, once liner sheet 26 is peeled away, the adhesive surface 30 of stickers 24 is exposed to the environment and a non-adhesive, or less adhesive, surface of stickers 24 remains mounted upon transfer sheet 22. Stickers 24 are mounted in a desired configuration on transfer sheet 22 in the shape of a clock dial and retain the dial shape when transfer sheet 22 is placed against a surface and removed therefrom.

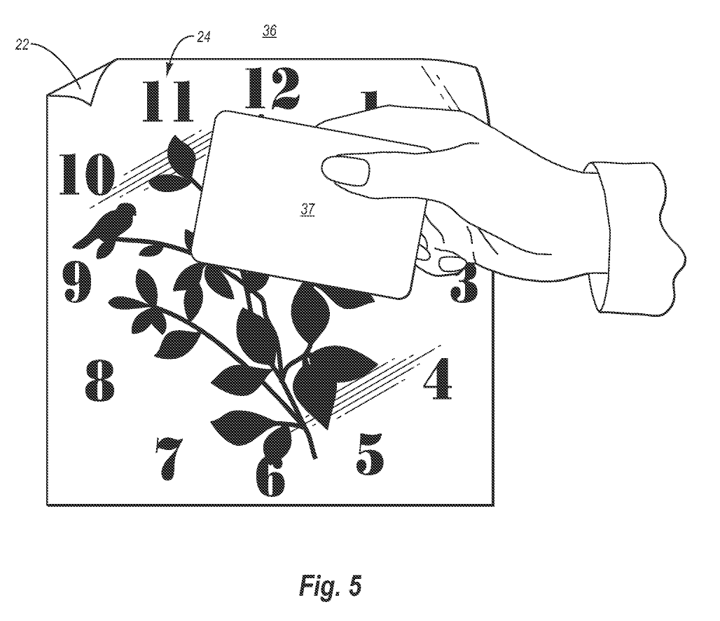

Once liner sheet 26 is removed, transfer sheet 22 with stickers 24 thereon in a dial shape is pressed against a wall surface 36 as depicted in FIG. 5. FIG. 5 demonstrates the placement of sheet 22 with stickers 24 thereon against wall 36. Transfer sheet 22 is preferably a transparent or translucent sheet provided in order to enable a user to visualize the appearance of stickers 24 and the placement of stickers 24 against a wall surface.

Once transfer sheet 22 and stickers 24 are on the wall, the user rubs the area where the stickers 24 are by hand and/or with smoothening applicator 37. The user then pulls the transfer sheet 22 carefully off and stickers 24 are left on the wall surface. The adhesive on the first side 30 of the stickers 24, which holds the stickers 24 to the surface 36, is stronger then an adhesive on the transfer sheet 22, enabling a user to perform this action.

Smoothening applicator 37, such as a rigid card, e.g., a credit card, may be used to smooth the wrinkles and bumps out of transfer sheet 22 and stickers 24 and to cause them to lay flat on surface 36.

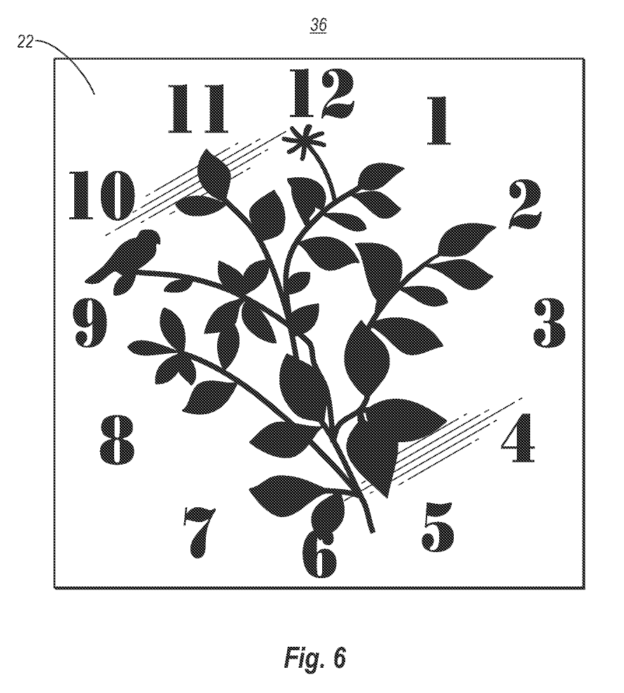

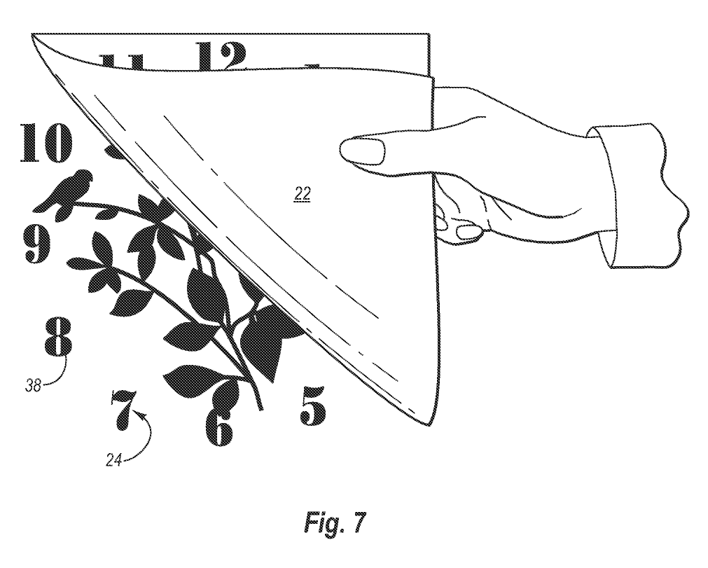

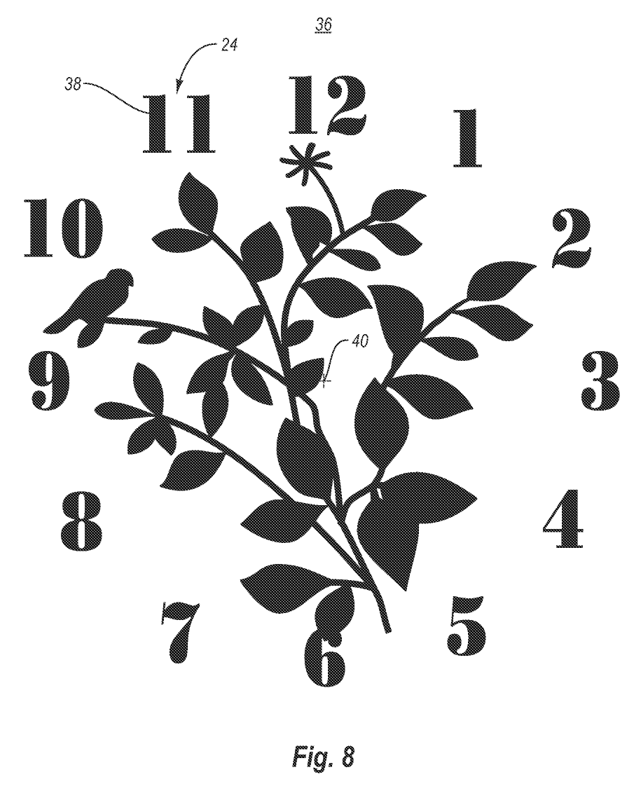

With reference to FIG. 6, once the wrinkles from transfer sheet 22 have been removed, sheet 22 is flat against wall surface 36 as are stickers 24. Sheet 22 can then be removed as illustrated in FIG. 7 from wall surface 36 and away from the non-adhesive side 38 of stickers 24. As shown in FIG. 8, the remaining structure comprises stickers 24 mounted in a circular array, forming a convenient decorative clock dial on wall surface 36 with the non-adhesive side 38 of stickers exposed to the environment. The decorative display formed by decorative stickers 28 enhances the appearance of the clock dial. The resulting decorative clock dial shown in FIG. 8 has the elegant appearance of being hand painted on a surface.

With reference now to FIG. 9, once sticker assembly 20 is placed on wall surface 36 to form a decorative dial, clock mechanism 12 can then be placed in the center 40 of the dial defined by the circular array of stickers 24 with the pivot point of the clock hands being located in the center 40 (FIG. 8) of the dial formed by the circular array of stickers 24. Stickers 24 thus provide the numerical indicia that provide a wall clock dial to correspond to the position of hands 16, 18 of clock mechanism 12.

Thus, plurality of stickers 24 provide a convenient decorative wall clock dial mounted directly onto a wall or other surface and can be associated with other decorative stickers 28 and are provided in a circular array having a center 40 such that clock mechanism 12 can be placed on said surface within the parameters of the dial to thereby provide a decorative wall clock.

FIGS. 1 thru 9 thus illustrate various components of a wall clock kit 10 for mounting on a wall surface comprising a clock mechanism having a clock motor assembly 14 that turns a plurality of clock hands 16, 18 in order to indicate the time of day and a sticker assembly 20. The stickers 24 serve as indicia in the form of one or more numbers or other markings or graduations corresponding to the time of day.

Stickers 24 have a first side 30 that is an adhesive side and is configured to stick to a wall surface 36. Stickers 24 also having a second side 38 that is non adhesive or less adhesive. First flexible sheet 22 acts as a transfer sheet and maintains the stickers 24 in a desired orientation until the stickers 24 are transferred to a surface; second flexible sheet 26 is a liner sheet, wherein the adhesive, first side of the stickers 24 is mounted on the liner sheet until being ready to be transferred to the surface.

The materials for transfer sheet 22, liner sheet 26, and plurality of stickers 24, and decorative stickers 28, can be obtained thru a variety of manners. Sheet 22 is preferably a translucent or transparent material upon which the second, non-adhesive side 38 of stickers 24 will temporarily stick when liner sheet 26 is removed from stickers 24 and from transfer sheet 22 (see FIG. 3). Liner sheet 26 is configured to be contacted by the first, adhesive side 30 of stickers 24 to protect the adhesive side 30 of stickers 24 and keep the adhesive new, but can be selectively removed therefrom. A variety of different materials can be used for these purposes.

Stickers 24 may be comprised of a vinyl type material, for example, with an adhesive placed on the first side 30 thereof to be able to be mounted on a wall surface. In one embodiment the transfer sheet 22 is a transfer paper while the liner sheet 26 is a coated paper. The adhesive on vinyl stickers 24 may be a removable adhesive glue, for example. The transfer sheet 22 may have an adhesive thereon to temporarily stick to: (i) the stickers 24 while making the transfer and (ii) to the liner sheet 26 prior to removing the liner sheet 26. This transfer sheet 22 leaves little or no adhesive or residue on the top of the vinyl sticker 24 once removed.

In one embodiment: (i) liner sheet 26 comprises wood free paper coated with polyethylene and silicon; (ii) transfer sheet 22 comprises a translucent or transparent wet strength, wood-free base paper coated with a latex-type adhesive, and (iii) stickers 24 comprise polyvinyl chloride, i.e., PVC, with an acrylic base, permanent adhesive on the adhesive side 30 thereof. In other examples, the stickers 24 and/or 28 can comprise a polypropylene based film that can be coated with a water-based adhesive.

Stickers 24 can be colored and tailored as desired and can have a design printed thereon. Stickers 24 maybe die cut, for example.

As the hands 16, 18 of clock mechanism 12 sweep around the perimeter defined by stickers 24, the stickers 24 indicate the time of day. Stickers 24 are examples of various type of indicia which can be used to indicate the time of day. Numbers 1-12 are shown in the accompanying drawings; however, a variety of other indicia may provide indications of the time of day such as roman numerals, letters, markings from various languages and font styles and a variety of other types of indicia that might be used to indicate the time of day according to a perceived or known pattern or nomenclature for understanding and interpreting the positions of clock hands 16, 18.

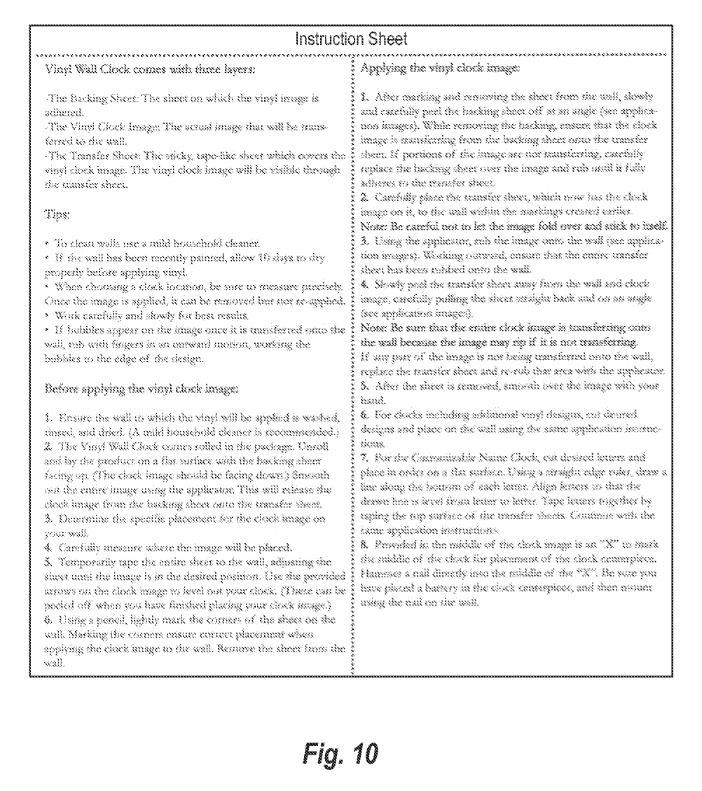

Thus, clock kit 10 of the present invention is comprised of clock mechanism 12, sticker assembly 20, and smoothening device 37. Related instruction materials, as shown in FIG. 10, and packaging (see FIG. 1a) to package the foregoing components may also be provided in the kit 10.

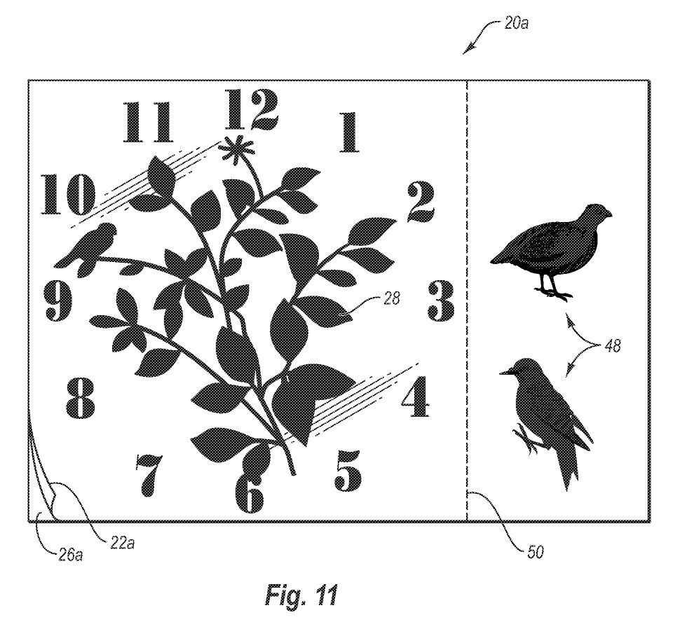

FIG. 11 is yet another embodiment of a sticker assembly 20a of the present invention having a transfer sheet 22a and a liner sheet 26a and the same stickers as the sticker assembly of FIG. 1, but further having additional stickers 48 for decorating the surfaces adjacent the surfaces covered by stickers 24 and/or decorating clock mechanism 14, for example. Sticker assembly 20a can be cut along line 50 prior to removal of liner sheet 26a, for example, and/or the portion of sticker assembly 20a including stickers 48 can be packaged separately from the portion containing stickers 24 and 28.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A clock kit, comprising:
a clock mechanism having a plurality of clock hands; and
a sticker assembly having a plurality of stickers providing indicia corresponding to a plurality of positions for the plurality of clock hands and positioned between at least one liner sheet and at least one transfer sheet, wherein a first adhesive force between a first side of the stickers and the liner sheet is less than a second adhesive force between a second, opposing side of the stickers and the transfer sheet, and wherein a third adhesive force between the first side of the stickers and a surface on which the clock kit is to be mounted is greater than the second adhesive force.

2. The clock kit of claim 1, wherein the indicia are provided as single complete pattern on the transfer sheet.

3. The clock kit of claim 1, wherein the indicia are provided as individual user-selectable elements on the transfer sheet.

4. The clock kit of claim 1, further comprising a first adhesive layer applied to the first side of the stickers.

5. The clock kit of claim 1, wherein a sticker of the sticker assembly has a thickness of less than 0.15 mm.

6. The clock kit of claim 5, wherein a sticker of the sticker assembly is formed from a polypropylene based film.

7. A wall clock kit, comprising:
a clock motor that turns a plurality of clock hands in order to indicate the time of day;
a separate clock dial having indicia positioned in a circular array, the clock dial being mountable on a wall surface independently from the clock motor, wherein
(i) the clock dial can be mounted on a wall surface; and
(ii) the clock motor can then be mounted on the wall surface with the indicia of the clock dial positioned about the periphery of the clock hands such that the indicia correspond to the movement of the clock hands; and
a transfer sheet configured to orient the clock dial in a desired position until the clock dial is transferred to a wall surface.

8. A wall clock as recited in claim 7, wherein the clock dial comprises a plurality of stickers and wherein the transfer sheet can be peeled off the stickers prior to placement of the sticker on the wall.

9. A wall clock kit as recited in claim 7, further comprising a liner sheet configured to cover an adhesive covered side of the dial.

10. A wall clock kit as recited in claim 7, wherein the dial comprises a sticker assembly, comprising one or more stickers comprising indicia configured to form one or more numbers corresponding to the time of day, the stickers having a first side that is an adhesive side and is configured to stick to a wall surface, the stickers also having a second side.

11. A wall clock kit as recited in claim 7, wherein the clock mechanism is configured to be mounted on a wall surface with the indicia of the dial positioned about a periphery of the clock hands such that indicia of the dial correspond to the movement of the clock hands.

12. A wall clock kit as recited in claim 7, further comprising an applicator for orienting the clock dial on the surface.

13. A wall clock kit as recited in claim 7, further comprising decorative stickers in addition to the indicia employed for the clock dial.

14. A wall clock kit as recited in claim 7, further comprising packaging material for packaging the components of the kit.

15. A method for manufacturing a wall clock kit having a clock dial that can be mounted on a wall surface separately from a clock mechanism, the manufacturing method comprising:
(i) providing a clock mechanism having a clock motor and a plurality of clock hands, the clock motor turning the clock hands in order to indicate the time of day;
(ii) providing a clock dial that is separate and independently mountable from the clock mechanism, the clock dial comprising at least one sticker that can be mounted on a wall surface, the one or more stickers comprising indicia configured to correspond to the position of the plurality of clock hands in order to identify the time of day, the one or more stickers having a first side and a second side, the first side having an adhesive surface that can be mounted on a wall;
(iii) providing a first flexible sheet and a second flexible sheet;
(iv) mounting the first side of the at least one sticker on the first flexible sheet; and
(v) mounting the second side of the at least one sticker on the first flexible sheet to form a sticker assembly, such that the first flexible sheet can be removed, exposing the adhesive, first side of the at least one sticker for placement on the wall, and such that the second flexible sheet can be removed from the second side of the at least one sticker once the adhesive, first side of the at least one sticker has been placed on the wall surface, and such that the clock mechanism can then be placed on the wall surface such that the indicia of the dial correspond to the movement of the plurality of clock hands.

16. A method as recited in claim 15, further comprising providing a container for packaging the sticker assembly and the clock mechanism.

17. A method as recited in claim 15, further comprising providing a smoothening applicator.

18. A method as recited in claim 17, further comprising providing instructions for assembling the clock kit.

19. A wall clock kit, comprising:
a clock mechanism comprising a clock motor that turns a plurality of clock hands in order to indicate the time of day;
a separate clock dial having indicia, the clock dial being mountable on a wall surface independently from the clock motor, wherein the clock dial has a first side and a second side, the first side having an adhesive thereon;
a liner sheet mounted on the first side of the clock dial, the liner sheet being configured to cover the adhesive on the first side of the clock dial;
a transfer sheet mounted on the second side of the clock dial, the transfer sheet being configured to be mounted on the second side of the dial until the clock dial is transferred to a wall surface, wherein
the liner sheet can be removed, exposing the adhesive, first side of the clock dial such that the clock dial can be mounted on a wall surface, and such that the transfer sheet can be removed from the second side of the clock dial once the adhesive, first side of the clock dial has been placed on the wall surface, and such that the clock mechanism can then be mounted on the wall surface with the indicia of the clock dial positioned about the periphery of the clock hands such that the indicia correspond to movement of the clock hands and such that pivot points of the clock hands are located in the center of the clock dial.

20. A wall clock kit as recited in claims 19, wherein the liner sheet comprises a first flexible sheet and the transfer sheet comprises a second flexible sheet.

21. A wall clock kit as recited in claim 19, wherein the clock dial has indicia positioned in a circular array.

22. A wall clock as recited in claim 19, wherein the clock dial comprises a plurality of stickers.

23. A wall clock kit as recited in claim 22, wherein the clock dial comprises one or more stickers comprising indicia corresponding to the time of day.

24. A wall clock kit as recited in claim 23, further comprising decorative stickers in addition to the indicia employed for the clock dial.

25. A wall clock kit as recited in claim 24, further comprising a container for packaging the dial, clock mechanism, and decorative stickers.

26. A wall clock kit as recited in claim 19, wherein a first adhesive force between the first side of the dial and the liner sheet is less than a second adhesive force between the second side of the dial and the transfer sheet, and wherein a third adhesive force between the first side of the dial and a surface on which the dial is mounted is greater than the second adhesive force.

27. A clock kit, comprising:
a clock mechanism having a plurality of clock hands; and
a separate clock dial having indicia corresponding to a plurality of positions for the plurality of clock hands, the clock dial being configured to be mounted on a wall surface independently from the clock mechanism, the clock dial having a first side and a second, opposing side, the first side having an adhesive layer thereon;
a liner sheet removably positioned on the adhesive layer such that the liner sheet can be removed, thereby exposing the adhesive layer; and
a transfer sheet mounted on the second side of the clock dial, wherein the clock kit is configured such that an adhesive force between the first side of the dial and a wall surface on which the first side of the dial is mounted is greater than the adhesive force between the second side of the dial and the transfer sheet, such that the transfer sheet can be removed from the second side of the clock dial once the adhesive, first side of the clock dial has been placed on the wall surface.

28. The clock kit of claim 27, wherein an adhesive force between the first side of the dial and the liner sheet is less than an adhesive force between the second side of the dial and the transfer sheet.

29. The clock kit of claim 27, wherein the clock dial comprises a single pattern.

30. The clock kit of claim 27, wherein a sticker of the clock dial has a thickness of less than 0.15 mm.

31. The clock kit of claim 27, wherein a sticker of the clock dial is formed from a polypropylene based film.

32. The clock kit of claim 27, wherein pivot points of the clock hands can be positioned in the center of the clock dial.

33. A clock kit having a clock dial that is independent from the clock mechanism thereof, the clock kit comprising:
a clock mechanism having a clock motor assembly and pair of clock hands, the hands being connected to and operated by the clock motor assembly, the clock mechanism being selectively mounted on a surface; and
indicia positioned in the form of a clock dial and configured to be mounted separately from the clock mechanism on the surface, the indicia being selectively positioned on the surface such that the clock mechanism is selectively positioned on the surface with the indicia corresponding to the locations of the clock hands and wherein the indicia are oriented in a circular array on a transfer sheet that retains the indicia in a circular array until the indicia are transferred to the surface.

34. A clock kit as recited in claim 33, wherein the indicia comprise a plurality of objects in the shape of numerals.

35. A clock kit as recited in claim 33, wherein the plurality of indicia comprise one or more stickers.

36. A clock kit as recited in claim 33, wherein the clock hands include an hour hand and a minute hand.

37. A wall clock kit, comprising:
a clock motor that turns a plurality of clock hands in order to indicate the time of day;
a separate clock dial having indicia positioned in a circular array, the clock dial being mountable on a wall surface independently from the clock motor, wherein
(iii) the clock dial can be mounted on a wall surface; and
(iv) the clock motor can then be mounted on the wall surface with the indicia of the clock dial positioned about the periphery of the clock hands such that the indicia correspond to the movement of the clock hands; and
a transfer sheet configured to orient the clock dial in a desired position until the clock dial is transferred to a wall surface.

38. A wall clock as recited in claim 37, wherein the clock dial comprises a plurality of stickers and wherein the transfer sheet can be peeled off the stickers prior to placement of the sticker on the wall.

39. A wall clock kit as recited in claim 37, further comprising a liner sheet configured to cover an adhesive covered side of the dial.

40. A wall clock kit as recited in claim 37, wherein the dial comprises a sticker assembly, comprising one or more stickers comprising indicia configured to form one or more numbers corresponding to the time of day, the stickers having a first side that is an adhesive side and is configured to stick to a wall surface, the stickers also having a second side.

41. A wall clock kit as recited in claim 37, wherein the clock mechanism is configured to be mounted on a wall surface with the indicia of the dial positioned about a periphery of the clock hands such that indicia of the dial correspond to the movement of the clock hands.

42. A wall clock kit as recited in claim 37, further comprising an applicator for orienting the clock dial on the surface.

43. A wall clock kit as recited in claim 37, further comprising decorative stickers in addition to the indicia employed for the clock dial.

44. A wall clock kit as recited in claim 37, further comprising packaging material for packaging the components of the kit.
